(19) United States
(12) Patent Application Publication
(10) Pub. No.: US 2026/0337532 A1
(43) Pub. Date: Oct. 29, 2026

(54) SOLID DETERGENT FORMULATION

(71) Applicant: BASF SE, Ludwigshafen am Rhein (DE)

(72) Inventors: Matthias ARNDT, Ludwigshafen am Rhein (DE); Fabian HABERLING, Ludwigshafen am Rhein (DE); Astrid SCHMIDT, Ludwigshafen am Rhein (DE); Markus HARTMANN, Ludwigshafen am Rhein (DE)

(21) Appl. No.: 19/487,327

(22) PCT Filed: May 13, 2024
(86) PCT No.: PCT/EP2024/063039

§ 371 Date: Nov. 24, 2025

(30) Foreign Application Priority Data
May 22, 2023 (EP) 23174551.4
May 22, 2023 (EP) 23174552.2

(51) Int. Cl. C11D 17/06; C11D 3/08; C11D 3/10; C11D 3/12; C11D 3/20; C11D 3/33; C11D 3/36; C11D 3/37; C11D 3/39

(52) U.S. Cl. CPC C11D 17/06; C11D 3/08; C11D 3/10; C11D 3/1213; C11D 3/2086; C11D 3/33; C11D 3/365; C11D 3/378; C11D 3/3905; C11D 2111/14

(57) ABSTRACT

comprising at least one heteroatom selected from N, O, S, and at least one ceramic oxide (B), wherein less than 1% of the ceramic oxide particles have a diameter of less than 10 μm.

The present invention refers to a solid detergent formulation comprising at least one organic chemical compound (A), comprising at least one heteroatom selected from N, O, S, and at least one ceramic oxide (B), wherein less than 1% of the ceramic oxide particles have a diameter of less than 10 μm.

Organic chemical compounds, comprising at least one heteroatom selected from N, O, S, may be subject to deterioration (e. g. coloring, malodor) in the presence of oxidizing compounds, e. g. oxygen or peroxy compounds. Thus, also solid detergent formulations containing at least one organic chemical compound, comprising at least one heteroatom selected from N, O, S, may be subject to deterioration in the same manner. In other words, the problem of deterioration may occur in a solid detergent formulation; the effects of deterioration (e. g., coloring and/or malodor) are undesired by customers.

As one example, the organic chemical compound (A) may be biodegradable and/or biobased. The organic chemical compound (A) may also be selected from anionic surfactants, cationic surfactants, non-ionic surfactants, polymers, enzymes, builders and chelating agents.

Chelating agents (also referred to as “complexing agents” hereinafter) such as methyl glycine diacetic acid (MGDA) and glutamic acid diacetic acid (GLDA) and their respective alkali metal salts are useful sequestrants for alkaline earth metal ions such as Ca²⁺ and Mg²⁺. For that reason, they are recommended and used for various purposes such as laundry detergents and for automatic dishwashing (ADW) formulations, in particular for so-called phosphate-free laundry detergents and phosphate-free ADW formulations. For shipping such complexing agents, in most cases either solids such as granules are being applied or aqueous solutions.

Granules and powders have the advantage of being essentially water-free. That means that in case of shipping, no water has to be shipped, and costs for extra weight can be avoided.

Many industrial users prefer to use chelating agents in the form of granules or powders which may contain, in addition to the at least one chelating agent, at least one additional compound, in particular polymers. Methods for providing granules or powders of chelating agents, also in combination with other compounds like polymers, have been described in the art, for example in WO 2015/121170 A1.

As mentioned above, solid detergent formulations containing at least one organic chemical compound, comprising at least one heteroatom selected from N, O, S (e. g. aminocarboxylate chelating agents or biobased and/or biodegradable polymers), may be subject to deterioration, which may lead to undesired effects, like coloring (yellowing) of the solid composition and/or malodor.

Thus, one objective of the present invention was to overcome the problems and disadvantages mentioned above.

In particular, it was an objective of the present invention to provide a solid detergent formulation comprising at least one organic chemical compound (A), comprising at least one heteroatom selected from N, O, S, which reduces or avoids deterioration and its side effects (in particular, coloring and/or malodor).

It was furthermore an objective of the present invention to provide a process to manufacture said solid detergent formulation.

Surprisingly, it was found that a solid detergent formulation which solves the above problems may be provided by adding a ceramic oxide (B).

Thus, one subject of the present invention is a solid detergent formulation comprising at least one organic chemical compound (A), comprising at least one heteroatom selected from N, O, S, and at least one ceramic oxide (B), wherein, preferably, less than 1% by weight of the ceramic oxide particles have a diameter of less than 10 μm. The amount of ceramic oxide particles with a certain diameter may be determined by a sieving analysis (e. g. as defined in German industry norms DIN 66165-1 and 66165-2), e. g. by using a sieve with apertures of 10 μm, sieving and weighing.

The term “solid” refers to its general meaning and normal conditions (at room temperature, i. e. 20 °C).

The inventive solid detergent formulation may be in the form of a granule or a powder, or in the form of a tablet or pouch.

A further subject of the present invention is also a process for manufacturing the inventive solid detergent formulation.

Another subject of the present application is also the use of the inventive solid detergent formulation, or a solid detergent formulation obtainable according to the inventive process, in home care applications, preferably dishwashing applications, particularly automatic dishwashing applications.

As mentioned, the organic chemical compound (A) may be biodegradable and/or biobased.

Biodegradable in the sense of the present invention means that said organic chemical compound (A) demonstrates at least 20%, preferably at least 40% or more preferably at least 60% biodegradability according to standard OECD 301F within 56 days, preferably within 28 days.

For the purposes of this invention, aerobic biodegradation in wastewater according to OECD 301F is expressed as a percentage of the theoretical oxygen demand (ThOD, which is measured by the elemental analysis of the compound of interest), which is needed to completely biodegrade the polymer sample. Thus, the amount of oxygen taken up by the microbial population during biodegradation of the test substance (corrected for uptake by blank inoculum, run in parallel) is expressed as a percentage of ThOD. The obtained values are preferably measured in triplicate using the OECD 301F manometric respirometry method. The consumption of oxygen is determined by measuring the change in pressure in the apparatus using an OxiTop® C (Xylem 35 Analytics Germany Sales GmbH & Co KG).

The term biobased refers to a compound which is made, at least in a certain percentage (of at least 50% by weight, relating to the final product, preferably at least 75% by weight) based on renewable, carbon-based resources, as opposed to compounds made (at least in a certain percentage of at least 50% by weight, relating to the final product) based on non-renewable resources, such as petroleum. Examples of biobased compounds are sugar-derivatives.

In one embodiment of the inventive solid detergent formulation, the organic chemical compound (A) is selected from anionic surfactants, cationic surfactants, non-ionic surfactants, polymers, enzymes, builders and chelating agents. The organic chemical compound (A) in the inventive solid detergent formulation may be, in a preferred embodiment, selected from aminocarboxylates, more preferably selected from MGDA, GLDA, IDS, EDDS and their mixtures and their respective alkali metal salts, particularly MGDA, e. g. MGDA trisodium salt.

In another embodiment of the inventive solid detergent formulation, the organic chemical compound (A) is selected from biobased and/or biodegradable polymers, preferably selected from polyamides, polyesters, polysaccharides and polyaspartic acid, particularly polyaspartic acid.

Polyaspartic acid is well known as biodegradable dispersing and scale inhibiting polymer. Three main methods have been developed for the industrial production of polyaspartic acid and its sodium salts:
(1) Thermal polycondensation of aspartic acid followed by alkaline hydrolysis of the intermediate polysuccinimide;
(2) Thermal polycondensation of aspartic acid in the presence of an acid catalyst such as phosphoric acid, sulfuric acid or methanesulfonic acid followed by alkaline hydrolysis of the intermediate polysuccinimide;
(3) Polymerization of maleic acid anhydride in the presence of ammonia or ammonium salts followed by alkaline hydrolysis of the intermediate polysuccinimide.

Regardless of the synthesis route, the intermediate polysuccinimide has to be hydrolyzed by means of e.g. sodium hydroxide in order to obtain an aqueous polyaspartate solution. Acidification of the polyaspartate solution with mineral acids such as hydrochlorid or sulfur acid gives the polyaspartic acid.

Modified polyaspartic acid which can be used according to the present invention is preparable by polycondensation of
(i) 50 to 99 mol %, preferably 60 to 95 mol %, particularly preferably 80 to 95 mol %, of aspartic acid; and
(ii) 1 to 50 mol %, preferably 5 to 40 mol %, particularly preferably 5 to 20 mol %, of at least one carboxyl-containing compound,
and subsequent hydrolysis of the co-condensates with the addition of a base, for example sodium hydroxide solution, wherein (ii) is not an aspartic acid.

The carboxyl-containing compound (ii) used in connection with the preparation of the polyaspartic acid to be used according to the invention can be, inter alia, a carboxylic acid (monocarboxylic acid or polycarboxylic acid), a hydroxycarboxylic acid and/or an amino acid (apart from aspartic acid). Such carboxylic acids or hydroxycarboxylic acids are preferably polybasic. In this connection, polybasic carboxylic acids can thus be used in the preparation of the polyaspartic acid to be used according to the invention, e.g. oxalic acid, adipic acid, fumaric acid, maleic acid, itaconic acid, aconitic acid, succinic acid, malonic acid, suberic acid, azelaic acid, diglycolic acid, glutaric acid, C₁-C₂₆ alkylsuccinic acids (e.g. octylsuccinic acid), C₂-C₂₆ alkenylsuccinic acids (e.g. octenylsuccinic acid), 1,2,3-propanetricarboxylic acid, 1,1,3,3-propanetetracarboxylic

acid, 1,1,2,2-ethanetetracarboxylic acid, 1,2,3,4-butanetetracarboxylic acid, 1,2,2,3-propanetetracarboxylic acid, or 1,3,3,5-pentanetetracarboxylic acid. Furthermore, in this connection it is also possible to use polybasic hydroxycarboxylic acids, e.g. citric acid, isocitric acid, mucic acid, tartaric acid, tartronic acid, or malic acid. Amino acids that can be used in this connection are, inter alia, aminocarboxylic acids (e.g. glutamic acid, cysteine), basic diaminocarboxylic acids (e.g. lysine, arginine, histidine, aminocaprolactam), neutral amino acids (e.g. glycine, alanine, valine, leucine, isoleucine, methionine, cysteine, norleucine, caprolactam, asparagine, isoasparagine, glutamine, isoglutamine), aminosulfonic acids (e.g. taurine), hydroxylamino acids (e.g. hydroxyproline, serine, threonine), iminocarboxylic acids (e.g. proline, iminodiacetic acid), or aromatic and heterocyclic amino acids (e.g. anthranilic acid, tryptophan, tyrosine, histidine), but not aspartic acid. Preferred carboxyl-containing compounds (ii) in connection with the preparation of the modified polyaspartic acids to be used according to the invention are 1,2,3,4-butanetetracarboxylic acid, citric acid, glycine, glutamic acid, itaconic acid, succinic acid, taurine, maleic acid and glutaric acid, particularly preferably 1,2,3,4-butanetetracarboxylic acid, citric acid, glycine and glutamic acid.

The molecular weight (Mw) of the (modified) polyaspartic acid can easily be tuned by varying the reaction conditions. Molecular weights between 1000 g/mol and 100 000 g/mol can be achieved by simple adjustion of the process parameters (temperature, catalyst, reaction time).

The preferred molecular weight of the (modified) polyaspartic acid used according to the present invention lies in the range between 1000 g/mol and 20 000 g/mol, preferably between 1500 and 15 000 g/mol and particularly preferably between 2000 and 10 000 g/mol.

The aspartic acid (i) used in connection with the preparation of the (modified) polyaspartic acid to be used according to the invention can either be L- or D- and DL-aspartic acid. Preference is given to using L-aspartic acid

The inventive solid detergent formulation may be used, inter alia, in home care applications, preferably detergent applications. The inventive solid composition may particularly be useful in dishwashing applications, especially automatic dishwashing applications.

The inventive solid detergent formulation may also be used in laundry applications or industrial and institutional cleaning applications.

The inventive solid detergent formulation may be part of a cleaning agent or may form a cleaning agent, containing the inventive solid detergent formulation, and, optionally, at least one peroxy compound, and optionally further comprising an antimicrobial agent selected from the group consisting of 2-phenoxyethanol; preferably comprising said antimicrobial agent in an amount ranging from 2 ppm to 5% by weight of the composition; more preferably comprising 0.1 to 2% of phenoxyethanol.

The term “cleaning agents” includes compositions for dishwashing, especially hand dishwash and automatic dishwashing and ware-washing, and compositions for hard surface cleaning such as, but not limited to compositions for bathroom cleaning, kitchen cleaning, floor cleaning, descaling of pipes, window cleaning, car cleaning including truck cleaning, furthermore, open plant cleaning, cleaning-in-place, metal cleaning, disinfectant cleaning, farm cleaning, high pressure cleaning, and in addition, laundry detergent compositions.

Such cleaning agents may be liquids, gels or preferably solids at ambient temperature, solids cleaning agents being preferred. They may be in the form of a powder or in the form of a unit dose, for example as a tablet or pouch.

Another aspect of the present invention is therefore the use of the inventive solid detergent formulation as or for the manufacture of a cleaning agent that contains at least one bleaching agent, and in particular for the manufacture of cleaning agent for fibers or hard surfaces, wherein said cleaning agent contains at least one peroxy compound. Another aspect of the present invention is a process for making at a cleaning agent by combining at least one inventive inventive solid composition with at least one bleaching agent, preferably at least one peroxy compound. Another aspect of the present invention is a cleaning agent, hereinafter also being referred to as inventive cleaning agent. Inventive cleaning agents contain at least one bleaching agent and at least one inventive solid composition. Inventive cleaning agents show a reduced tendency for yellowing and therefore have an extended shelve-life. Examples of suitable peroxy compounds are sodium perborate, anhydrous or for example as monohydrate or as tetrahydrate or so-called dihydrate, sodium percarbonate, anhydrous or, for example, as monohydrate, hydrogen peroxide, persulfates, organic peracids such as peroxylauric acid, peroxystearic acid, peroxy-α-naphthoic acid, 1,12-diperoxydodecanedioic acid, perbenzoic acid, peroxylauric acid, 1,9-diperoxyazelaic acid, diperoxyisophthalic acid, in each case as free acid or as alkali metal salt, in particular as sodium salt, also sulfonylperoxy acids and cationic peroxy acids.

In a preferred embodiment, peroxy compound is selected from inorganic percarbonates, persulfates and perborates. Examples of sodium percarbonates are 2 Na₂CO₃·3H₂O₂. Examples of sodium perborate are (Na₂[B(OH)₂(O₂)]₂), sometimes written as NaBO₂·O₂·3H₂O instead. Most preferred peroxy compound is sodium percarbonate.

As mentioned above, the organic chemical compound (A) in the inventive solid detergent formulation (and in the inventive cleaning agent) may, in one embodiment, be selected from anionic surfactants, cationic surfactants, nonionic surfactants.

Preferred non-ionic surfactants are alkoxylated alcohols, di- and multiblock copolymers of ethylene oxide and propylene oxide and reaction products of sorbitan with ethylene oxide or propylene oxide, alkyl polyglycosides (APG), hydroxyalkyl mixed ethers and amine oxides.

Preferred examples of alkoxylated alcohols and alkoxylated fatty alcohols are, for example, compounds of the general formula (II)

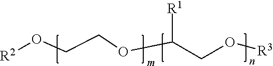

in which the variables are defined as follows:
R¹ is identical or different and selected from hydrogen and linear C₁-C₁₀-alkyl, preferably in each case identical and ethyl and particularly preferably hydrogen or methyl,
R² is selected from C₈-C₂₂-alkyl, branched or linear, for example n-C₈H₁₇, n-C₁₀H₂₁, n-C₁₂H₂₅, n-C₁₄H₂₉, n-C₁₆H₃₃ or n-C₁₈H₃₇,
R³ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,

m and n are in the range from zero to 300, where the sum of n and m is at least one, preferably in the range of from 3 to 50. Preferably, m is in the range from 1 to 100 and n is in the range from 0 to 30.

In one embodiment, compounds of the general formula (II) may be block copolymers or random copolymers, preference being given to block copolymers.

Other preferred examples of alkoxylated alcohols are, for example, compounds of the general formula (III)

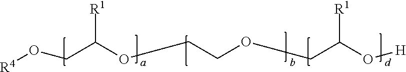

in which the variables are defined as follows:
R¹ is identical or different and selected from hydrogen and linear C₁-C₀-alkyl, preferably identical in each case and ethyl and particularly preferably hydrogen or methyl,
R⁴ is selected from C₆-C₂₀-alkyl, branched or linear, in particular n-C₈H₁₇, n-C₁₀H₂₁, n-C₁₂H₂₅, n-C₁₄H₂₉, n-C₁₆H₃₃, n-C₁₈H₃₇,
a is a number in the range from zero to 10, preferably from 1 to 6,
b is a number in the range from 1 to 80, preferably from 4 to 20,
d is a number in the range from zero to 50, preferably 4 to 25.

The sum a+b+d is preferably in the range of from 5 to 100, even more preferably in the range of from 9 to 50. Preferred examples for hydroxyalkyl mixed ethers are compounds of the general formula (IV)

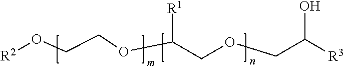

in which the variables are defined as follows:
R¹ is identical or different and selected from hydrogen and linear C₁-C₁₀-alkyl, preferably in each case identical and ethyl and particularly preferably hydrogen or methyl,
R² is selected from C₈-C₂₂-alkyl, branched or linear, for example iso-C₁₁H₂₃, iso-C₁₃H₂₇, n-C₈H₁₇, n-C₁₀H₂₁, n-C₁₂H₂₅, n-C₁₄H₂₉, n-C₁₆H₃₃ or n-C₁₈H₃₇,
R³ is selected from C₁-C₁₈-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, isodecyl, n-dodecyl, n-tetradecyl, n-hexadecyl, and n-octadecyl.

The variables m and n are in the range from zero to 300, where the sum of n and m is at least one, preferably in the range of from 5 to 50. Preferably, m is in the range from 1 to 100 and n is in the range from 0 to 30.

Compounds of the general formula (II) and (III) may be block copolymers or random copolymers, preference being given to block copolymers.

Further suitable nonionic surfactants are selected from di- and multiblock copolymers, composed of ethylene oxide and propylene oxide. Further suitable nonionic surfactants are selected from ethoxylated or propoxylated sorbitan esters. Amine oxides or alkyl polyglycosides, especially linear C₄-C₁₆-alkyl polyglucosides and branched C₈-C₁₄-alkyl polyglycosides such as compounds of general average formula (V) are likewise suitable.

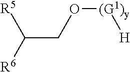

wherein the variables are defined as follows:
R⁵ is C₁-C₄-alkyl, in particular ethyl, n-propyl or isopropyl,
R⁶ is —(CH₂)₂-R⁵,
G¹ is selected from monosaccharides with 4 to 6 carbon atoms, especially from glucose and xylose,
y in the range of from 1.1 to 4, y being an average number.

Further examples of non-ionic surfactants are compounds of general formula (VII) and (VIII)

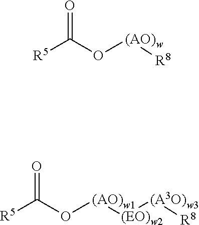

AO is selected from ethylene oxide, propylene oxide and butylene oxide,
EO is ethylene oxide, CH₂CH₂—O,
R⁸ selected from C₈-C₁₈-alkyl, branched or linear, and R⁵ is defined as above.
A₃O is selected from propylene oxide and butylene oxide,
w is a number in the range of from 15 to 70, preferably 30 to 50,
w1 and w3 are numbers in the range of from 1 to 5, and
w2 is a number in the range of from 13 to 35.

An overview of suitable further nonionic surfactants can be found in EP-A 0 851 023 and in DE-A 198 19 187. Mixtures of two or more different nonionic surfactants may also be present.

Other surfactants that may be present are selected from amphoteric (zwitterionic) surfactants and anionic surfactants and mixtures thereof.

Examples of amphoteric surfactants are those that bear a positive and a negative charge in the same molecule under use conditions. Preferred examples of amphoteric surfactants are so-called betaine-surfactants. Many examples of betaine-surfactants bear one quaternized nitrogen atom and one carboxylic acid group per molecule. A particularly preferred example of amphoteric surfactants is cocamidopropyl betaine (lauramidopropyl betaine). Examples of amine oxide surfactants are compounds of the general formula (IX)

R⁷R⁸R⁹N→O (IX)

wherein R⁷, R⁸ and R⁹ are selected independently from each other from aliphatic, cycloaliphatic or C₂-C₄-alkylene C₁₀-C₂₀-alkylamido moieties. Preferably, R⁷ is selected from C₈-C₂₀-alkyl or C₂-C₄-alkylene C₁₀-C₂₀-alkylamido and R⁸ and R⁹ are both methyl.

A particularly preferred example is lauryl dimethyl aminoxide, sometimes also called lauramine oxide. A further particularly preferred example is cocamidylpropyl dimethylaminoxide, sometimes also called cocamidopropylamine oxide.

Examples of suitable anionic surfactants are alkali metal and ammonium salts of C₈-C₁₈-alkyl sulfates, of C₈-C₁₈-fatty alcohol polyether sulfates, of sulfuric acid half-esters of ethoxylated C₄-C₁₂-alkylphenols (ethoxylation: 1 to 50 mol of ethylene oxide/mol), C₁₂-C₁₈ sulfo fatty acid alkyl esters, for example of C₁₂-C₁₈ sulfo fatty acid methyl esters, furthermore of C₁₂-C₁₈-alkylsulfonic acids and of C₁₀-C₁₈-alkylarylsulfonic acids. Preference is given to the alkali metal salts of the aforementioned compounds, particularly preferably the sodium salts.

Further examples for suitable anionic surfactants are soaps, for example the sodium or potassium salts of stearoic acid, oleic acid, palmitic acid, ether carboxylates, and alkylether phosphates.

Preferably, laundry detergent compositions contain at least one anionic surfactant.

In one embodiment of the present invention, inventive solid detergent formulations or cleaning agents that are determined to be used as laundry detergent compositions may contain 0.1 to 60% by weight of at least one surfactant, selected from anionic surfactants, amphoteric surfactants and amine oxide surfactants.

In one embodiment of the present invention, inventive solid detergent formulations or cleaning agents that are determined to be used for hard surface cleaning may contain 0.1 to 60% by weight of at least one surfactant, selected from anionic surfactants, amphoteric surfactants and amine oxide surfactants.

In a preferred embodiment, inventive solid detergent formulations or cleaning agents do not contain any anionic detergent.

Inventive cleaning agents may comprise one or more bleach catalysts. Bleach catalysts can be selected from bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Inventive cleaning agents may comprise one or more bleach activators, for example N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Further examples of suitable bleach activators are tetraacetylethylenediamine (TAED) and tetraacetylhexylenediamine.

Inventive cleaning agents may comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, inventive cleaning agents comprise in total in the range from 0.1 to 1.5% by weight of corrosion inhibitor.

Inventive cleaning agents may comprise one or more builders, selected from organic and inorganic builders. Examples of suitable inorganic builders are sodium sulfate or sodium carbonate or silicates, in particular sodium disilicate and sodium metasilicate, zeolites, sheet silicates, in particular those of the formula α-Na₂Si₂O₅, β-Na₂Si₂O₅, and δ-Na₂Si₂O₅, also fatty acid sulfonates, α-hydroxypropionic acid, alkali metal malonates, fatty acid sulfonates, alkyl and alkenyl disuccinates, tartaric acid diacetate, tartaric acid monoacetate, oxidized starch, and polymeric builders, for example polycarboxylates and polyaspartic acid.

Examples of organic builders are especially polymers and copolymers. In one embodiment of the present invention, organic builders are selected from polycarboxylates, for example alkali metal salts of (meth)acrylic acid homopolymers or (meth)acrylic acid copolymers, partially or completely neutralized with alkali.

Suitable comonomers for (meth)acrylic acid are monoethylenically unsaturated dicarboxylic acids such as maleic acid, fumaric acid, maleic anhydride, itaconic acid and citraconic acid. A suitable polymer is in particular polyacrylic acid, which preferably has an average molecular weight Mw in the range from 2000 to 40 000 g/mol, preferably 2000 to 10 000 g/mol, in particular 3000 to 8000 g/mol. Also of suitability are copolymeric polycarboxylates, in particular those of acrylic acid with methacrylic acid and of acrylic acid or methacrylic acid with maleic acid and/or fumaric acid, and in the same range of molecular weight.

It is also possible to use copolymers of at least one monomer from the group consisting of monoethylenically unsaturated C₃-C₁₀-mono- or C₄-C₁₀-dicarboxylic acids or anhydrides thereof, such as maleic acid, maleic anhydride, acrylic acid, methacrylic acid, fumaric acid, itaconic acid and citraconic acid, with at least one hydrophilic or hydrophobic monomer as listed below.

Suitable hydrophobic monomers are, for example, isobutene, diisobutene, butene, pentene, hexene and styrene, olefins with 10 or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having on average 12 to 100 carbon atoms per molecule.

Suitable hydrophilic monomers are monomers with sulfonate or phosphonate groups, and also nonionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here may comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

A further example of builders is carboxymethyl inulin.

Moreover, amphoteric polymers can also be used as builders.

Inventive cleaning agents may comprise, for example, in the range from in total 10 to 70% by weight, preferably from in total 10 to 50% by weight, more preferably up to 20% by weight, of builder.

In one embodiment of the present invention, inventive cleaning agents according to the invention may comprise one or more co-builders.

Inventive cleaning agents may comprise one or more antifoams, selected for example from silicone oils and paraffin oils.

In one embodiment of the present invention, inventive cleaning agents comprise in total in the range from 0.05 to 0.5% by weight of antifoam.

Inventive cleaning agents may comprise one or more enzymes. Examples of enzymes are lipases, hydrolases, amylases, proteases, cellulases, esterases, pectinases, lactases and peroxidases.

In one embodiment of the present invention, inventive cleaning agents may comprise, for example, up to 5% by weight of enzyme, preference being given to 0.1 to 3% by weight. Said enzyme may be stabilized, for example with the sodium salt of at least one C₁-C₃-carboxylic acid or C₄-C₁₀-dicarboxylic acid. Preferred are formates, acetates, adipates, and succinates.

In one embodiment of the present invention, inventive cleaning agents may comprise at least one zinc salt. Zinc salts can be selected from water-soluble and water-insoluble zinc salts. In this connection, within the context of the present invention, water-insoluble is used to refer to those zinc salts which, in distilled water at 25 °C, have a solubility of 0.1 g/l or less. Zinc salts which have a higher solubility in water are accordingly referred to within the context of the present invention as water-soluble zinc salts.

In one embodiment of the present invention, zinc salt is selected from zinc benzoate, zinc gluconate, zinc lactate, zinc formate, ZnCl₂, ZnSO₄, zinc acetate, zinc citrate, Zn(NO₃)₂, Zn(CH₃SO₃)₂ and zinc gallate, preferably ZnCl₂, ZnSO₄, zinc acetate, zinc citrate, Zn(NO₃)₂, Zn(CH₃SO₃)₂ and zinc gallate.

In another embodiment of the present invention, zinc salt is selected from ZnO, ZnO·aq, Zn(OH)₂ and ZnCO₃. Preference is given to ZnO·aq.

In one embodiment of the present invention, zinc salt is selected from zinc oxides with an average particle diameter (weight-average) in the range from 10 nm to 100 μm.

The cation in zinc salt can be present in complexed form, for example complexed with ammonia ligands or water ligands, and in particular be present in hydrated form. To simplify the notation, within the context of the present invention, ligands are generally omitted if they are water ligands.

Depending on how the pH value of mixture according to the invention is adjusted, zinc salt can change. Thus, it is for example possible to use zinc acetate or ZnCl₂ for preparing formulation according to the invention, but this converts at a pH of 8 or 9 in an aqueous environment to ZnO, Zn(OH)₂ or ZnO·aq, which can be present in non-complexed or in complexed form.

Zinc salt may be present in those inventive cleaning agents that are solid at room temperature. In such inventive cleaning agents zinc salts are preferably present in the form of particles which have for example an average diameter (number-average) in the range from 10 nm to 100 μm, preferably 100 nm to 5 μm, determined for example by X-ray scattering.

Zinc salt may be present in those inventive cleaning agents that are liquid at room temperature. In such inventive cleaning agents zinc salts are preferably present in dissolved or in solid or in colloidal form.

In one embodiment of the present invention, inventive cleaning agents comprise in total in the range from 0.05 to 0.4% by weight of zinc salt, based in each case on the dry content of the cleaning agent in question.

Here, the fraction of zinc salt is given as zinc or zinc ions. From this, it is possible to calculate the counterion fraction. In one embodiment of the present invention, inventive cleaning agents are free from heavy metals apart from zinc compounds. Within the context of the present, this may be understood as meaning that inventive cleaning agents are free from those heavy metal compounds which do not act as bleach catalysts, in particular of compounds of iron and of bismuth. Within the context of the present invention, “free from” in connection with heavy metal compounds is to be understood as meaning that the content of heavy metal compounds which do not act as bleach catalysts is in sum in the range from 0 to 100 ppm, determined by the leach method and based on the dry content. Preferably, inventive cleaning agents has, apart from zinc, a heavy metal content below 0.05 ppm, based on the dry content of the formulation in question. The fraction of zinc is thus not included.

Within the context of the present invention, “heavy metals” are deemed to be all metals with a specific density of at least 6 g/cm³ with the exception of zinc. In particular, the heavy metals are metals such as bismuth, iron, copper, lead, tin, nickel, cadmium and chromium.

Preferably, inventive cleaning agents comprise no measurable fractions of bismuth compounds, for example less than 1 ppm.

Inventive cleaning agents are excellent for cleaning hard surfaces and fibres. For example, they may be used in dishwashing applications, preferably automatic dishwashing applications.

In one embodiment of the present invention, inventive cleaning agents comprise one or more further ingredient such as fragrances, dyestuffs, organic solvents, buffers, disintegrants for tablets (“tabs”), and/or acids such as methylsulfonic acid.

Laundry detergents according to the invention are useful for laundering any type of laundry, and any type of fibres. Fibres can be of natural or synthetic origin, or they can be mixtures of natural of natural and synthetic fibres. Examples of fibers of natural origin are cotton and wool. Examples for fibers of synthetic origin are polyurethane fibers such as Spandex® or Lycra®, polyester fibers, or polyamide fibers. Fibers may be single fibers or parts of textiles such as knitwear, wovens, or nonwovens.

Another aspect of the present invention is a process for making tablets for automatic dishwashing from inventive solid detergent formulations. Said process is hereinafter also referred to as pelletizing process according to the invention.

Inventive tablets are preferably made with the help of a machine, for example a tablet press.

The pelletizing process according to the invention can be carried out by mixing an inventive solid detergent formulation with at least one non-ionic surfactant and optionally one or more further substance and then compressing the mixture to give tablets. Examples of suitable non-ionic surfactants and further substances such as builders, enzymes are listed above. Particularly preferred examples of non-ionic surfactants are hydroxy mixed ethers, for example hydroxy mixed ethers of the general formula (V).

The ceramic oxide (B) may, in one embodiment, be selected from the list consisting of Al2O3, TiO2, CeO2 and ZrO2, preferably TiO2.

The ceramic oxide (B) may be applied as a solid, but also in a slurry in water. Also, a dispersion of ceramic oxide (B) in a polymer solution, e. g. of polyacrylate in water, or in a surfactant, may be used.

In an embodiment of the inventive solid detergent formulation, the amount of the ceramic oxide (B) is at least 0.01 weight %, referring to the total weight of the organic chemical compounds (A), preferably at least 0.1 weight %, preferably not more than 10 weight %.

As mentioned above, one subject of the present inventions is also a process for providing an inventive solid detergent formulation, comprising at least one organic chemical compound (A), comprising at least one heteroatom selected from N, O, S, preferably selected from biodegradable and/or biobased polymers and/or aminocarboxylates, by adding at least one ceramic oxide (B) to the organic chemical compounds (A) by physical mixing.

The physical mixing may be performed by any type of physical mixing, preferably in a plough share mixer or free fall mixer, and/or preferably at a temperature of 10 to 190 °C, more preferably 20 to 90 °C, and/or preferably at a speed of 20 to 120 rpm, more preferably 40 to 80 rpm, and/or preferably with a Froude number of 0.1 to 10, more preferably 1 to 3, and/or preferably at a filling level of 10 to 95%, more preferably 40 to 75%, and/or preferably at atmospheric pressure, and/or preferably at an average residence time of at least one minute, more preferably 2 to 60 minutes.

### WORKING EXAMPLES

Some aspects of the present invention are illustrated by the following, non-limiting experimental examples.

### Experiment 1. Discoloration with Sodium Percarbonate

### 1.1 Samples:

(M.1) sodium salt of MGDA granules
(Ci.1) sodium citrate dihydrate
(T.1) physical mixture of 99.5% by weight (M.1) and 0.5% by weight titanium dioxide
(T.2) physical mixture of 99.0% by weight (M.1) and 1.0% by weight titanium dioxide
(T.3) physical mixture of 98.0% by weight (M.1) and 2.0% by weight titanium dioxide
(T.4) physical mixture of 99.5% by weight (Ci.1) and 0.5% by weight titanium dioxide
(T.5) physical mixture of 98.0% by weight (Ci.1) and 2.0% by weight titanium dioxide
(Z.1) physical mixture of 99.5% by weight (M.1) and 0.5% by weight zirconium oxide
(Z.2) physical mixture of 99.0% by weight (M.1) and 1.0% by weight zirconium oxide
(Z.3) physical mixture of 98.0% by weight (M.1) and 2.0% by weight zirconium oxide

### 1.2 Procedure

10 g of the samples were mixed with 5 g Na-percarbonate and placed in a cell culture bottle with a semi permeable membrane to allow an exchange with the surrounding atmosphere. The vial was stored for 4 weeks in a climate-chamber at 35 °C and 70% humidity.

The discoloration—which is a yellowing in this case—of the stored mixtures was determined by measuring the b-value of the CIELAB color space (Mach5 measurement).

### Peroxide Test:

(P.1) start value
(P.2) discoloration after storage for 2 weeks (delta to previous measurement)
(P.3) discoloration after storage for 4 weeks (delta to previous measurement)
(P.4) total discoloration

The results are summarized in Table 1.

TABLE 1
Yellowing behavior

| | (P.1) | (P.2) | (P.3) | (P.4) |
|---|---|---|---|---|
| samples | [b-value] | [b-value] | [b-value] | [b-value] |
| (M.1) | 4.8 | 8.0 | 10.3 | 29.6 |
| (T.1) | 4.5 | 10.2 | 8.1 | 22.8 |
| (T.2) | 4.4 | 9.5 | 8.7 | 22.6 |
| (T.3) | 3.7 | 6.4 | 2.9 | 13.0 |
| (Z.1) | 4.8 | 9.8 | 12.5 | 27.1 |
| (Z.2) | 5.4 | 10.1 | 12.1 | 27.7 |
| (Z.3) | 5.0 | 11.2 | 7.7 | 23.9 |

### Experiment 2. Discoloration in ADW Formulation as Tablets

### 2.1 Composition of Formulation:

(F.1) formulation with polymer 1
(F.2) formulation with polymer 2
(C.1) percentage of sodium percarbonate
(C.2) percentage of sodium disilicate
(C.3) percentage of sodium carbonate
(C.4) percentage of sodium sulfate
(C.5) percentage of surfactant
(C.6) percentage of 1-Hydroxyethane-1,1-diphosphonic acid (HEDP)
(C.7) percentage of polymer 1 (Sokalan® CP 50-modified, sulfonated polycarboxylate polymer, sodium salt; available from BASF)
(C.8) percentage of polymer 2 (polyaspartic acid)
(C.9) percentage of sample

The composition of the ADW formulations is summarized in 2.

TABLE 2
composition of the ADW formulations

| | (C.1) | (C.2) | (C.3) | (C.4) | (C.5) | (C.6) | (C.7) | (C.8) | (C.9) |
|---|---|---|---|---|---|---|---|---|---|
| sample | [%] | [%] | [%] | [%] | [%] | [%] | [%] | [%] | [%] |
| (F.1) | 15.0 | 2.0 | 31.2 | 1.0 | 5.0 | 0.8 | 5.0 | 0 | 40.0 |
| (F.2) | 15.0 | 2.0 | 31.2 | 1.0 | 5.0 | 0.8 | 0 | 5.0 | 40.0 |

### 2.2 Samples:

(M.1) sodium salt of MGDA granules
(Ci.1) sodium citrate dihydrate
(T.1) physical mixture of 99.5% by weight (M.1) and 0.5% by weight titanium dioxide
(T.2) physical mixture of 99.0% by weight (M.1) and 1.0% by weight titanium dioxide
(T.3) physical mixture of 98.0% by weight (M.1) and 2.0% by weight titanium dioxide
(T.4) physical mixture of 99.5% by weight (Ci.1) and 0.5% by weight titanium dioxide
(T.5) physical mixture of 98.0% by weight (Ci.1) and 2.0% by weight titanium dioxide
(F.1.1) mixture of 60% by weight (F.1) with 40% by weight (M.1)
(F.1.2) mixture of 60% by weight (F.1) with 40% by weight (T.3)
(F.1.3) mixture of 60% by weight (F.1) with 40% by weight (Ci.1)
(F.1.4) mixture of 60% by weight (F.1) with 40% by weight (T.4)
(F.2.1) mixture of 60% by weight (F.2) with 40% by weight (M.1)
(F.2.2) mixture of 60% by weight (F.2) with 40% by weight (T.1)
(F.2.3) mixture of 60% by weight (F.2) with 40% by weight (T.2)
(F.2.4) mixture of 60% by weight (F.2) with 40% by weight (Ci. 1)
(F.2.5) mixture of 60% by weight (F.2) with 40% by weight (T.5)

### 2.3 Procedure

6.0 g of the samples were mixed with 8.25 g of the formulations (F.1) or (F.2). Subsequently, the formulations are pressed into a tablet in the ‘Laborpresse TW 20’ (Company: PO Weber) at 100 kN. Then the tablets were packed in a LD-PE bag. The tablets were stored for 4 weeks in a climate-chamber at 35 °C and 70% humidity.

The discoloration—which is a yellowing in this case—of the stored mixtures was determined by measuring the b-value of the CIELAB color space (Mach5 measurement).

### Discoloration Test:

(D.1) start value
(D.2) discoloration after storage for 2 weeks (delta to previous measurement)
(D.3) discoloration after storage for 4 weeks (delta to previous measurement)
(D.4) total discoloration

The results are summarized in Table 3.

TABLE 3
Discoloration behavior

| | (D.1) | (D.2) | (D.3) | (D.4) |
|---|---|---|---|---|
| samples | [b-value] | [b-value] | [b-value] | [b-value] |
| (F.1.1) | 2.4 | 3.6 | 3.5 | 9.5 |
| (F.1.2) | 2.5 | 3.3 | 3.4 | 9.3 |
| (F.1.3) | 1.9 | −0.1 | 0.8 | 2.7 |
| (F.1.4) | 1.9 | −0.1 | 0.4 | 2.1 |
| (F.2.1) | 4.2 | 4.5 | 5.2 | 13.9 |
| (F.2.2) | 3.5 | 4.1 | 5.0 | 12.6 |
| (F.2.3) | 3.7 | 3.6 | 5.0 | 12.3 |
| (F.2.4) | 4.5 | 1.4 | 1.5 | 7.3 |
| (F.2.5) | 3.8 | 1.1 | 0.9 | 5.7 |

1. A solid detergent formulation comprising at least one organic chemical compound (A), comprising at least one heteroatom selected from N, O, and S, and at least one ceramic oxide (B), wherein less than 1% by weight of the ceramic oxide particles have a diameter of less than 10 μm, as determined by sieving analysis as defined in German industry norms DIN 66165-1 and 66165-2, using a sieve with apertures of 10 μm.

2. The solid detergent formulation according to claim 1, wherein the organic chemical compound (A) is biodegradable, wherein said organic chemical compound (A) demonstrates at least 2-0% biodegradability according to standard OECD 301F within 56 days, and/or biobased.

3. The solid detergent formulation according to claim 1, wherein the organic chemical compound (A) is selected from anionic surfactants, cationic surfactants, non-ionic surfactants, polymers, enzymes, builders or chelating agents.

4. The solid detergent formulation according to claim 1, wherein the organic chemical compound (A) is selected from aminocarboxylates, optionally selected from MGDA, GLDA, IDS and EDDS.

5. The solid detergent formulation according to claim 1, wherein the organic chemical compound (A) is selected from biobased and/or biodegradable polymers, optionally selected from polyamides, polyesters, polysaccharides and polyaspartic acid.

6. The solid detergent formulation according to claim 1, wherein the ceramic oxide (B) is selected from the group consisting of Al2O3, TiO2, CeO2 and ZrO2.

7. The solid detergent formulation according to claim 1, wherein the amount of the ceramic oxide (B) is at least 0.01 weight %, referring to the total weight of the organic chemical compounds (A), optionally not more than 10 weight %.

8. A process for providing a solid detergent formulation according to claim 1, comprising at least one organic chemical compound (A), comprising at least one heteroatom selected from N, O, and S, optionally selected from biodegradable and/or biobased polymers and/or aminocarboxylates, by adding at least one ceramic oxide (B) to the organic chemical compounds (A) by physical mixing.

9. A process for providing a solid detergent formulation according to claim 8, wherein physical mixing is performed by a plough share mixer or free fall mixer.

10. (canceled)

11. The process according to claim 8, wherein physical mixing is performed at a temperature of 10 to 190 °C, and/or optionally at a speed of 20 to 120 rpm, and/or optionally with a Froude number of 0.1 to 10, and/or optionally at a filling level of 10 to 95%, and/or optionally at atmospheric pressure, and/or optionally at an average residence time of at least one minute.

12. A cleaning agent comprising the solid detergent formulation according to claim 1 and at least one bleaching agent.
